(19) United States
(12) Patent Application Publication
(10) Pub. No.: US 2024/0395141 A1
(43) Pub. Date: Nov. 28, 2024

(54) Automated Vehicle Control Distributed Network Apparatuses and Methods

(71) Applicant: LEMKO CORPORATION, SCHAUMBURG, IL (US)

(72) Inventors: Shaowei Pan, Kildeer, IL (US); Brian Ponte, Palatine, IL (US)

(21) Appl. No.: 18/510,422

(22) Filed: Nov. 15, 2023

Related U.S. Application Data
(63) Continuation-in-part of application No. 18/202,942, filed on May 28, 2023.

(51) Int. Cl. G08G 1/0967; G08G 1/04; G08G 1/052

(52) U.S. Cl. CPC G08G 1/096725; G08G 1/04; G08G 1/052; G08G 1/096766; B60W 10/04; B60W 10/20; B60W 60/001; B60W 2710/20; B60W 2720/106

(57) ABSTRACT

An automated vehicle control distributed network is operative to detect an emergency vehicle on a roadway; create a prediction model for the emergency vehicle; and send control commands to vehicles within a distance in front of the emergency vehicle to clear a path for the emergency vehicle based on the prediction model.

### CROSS-REFERENCE TO RELATED APPLICATIONS

The present application is a Continuation-in-Part of U.S. patent application Ser. No. 18/202,942, filed May 28, 2023, which further is a Continuation of U.S. patent application Ser. No. 18/075,429 filed Dec. 6, 2022, which issued on Jun. 6, 2023 as U.S. Pat. No. 11,670,162, which further was a Continuation of U.S. patent application Ser. No. 16/987,399 filed Aug. 7, 2020, which issued on Dec. 6, 2022 as U.S. Pat. No. 11,521,485, which further claimed priority to U.S. Provisional Patent Application No. 63/029,542, filed May 24, 2020, entitled “AUTOMATED VEHICLE CONTROL DISTRIBUTED NETWORK APPARATUSES AND METHODS” all of which are hereby incorporated by reference herein in their entirety, and all of which are assigned to the same assignee as the present application.

### FIELD OF THE DISCLOSURE

The present disclosure relates generally to the Internet-of-things (IoT) and more particularly to automated vehicle control methods and apparatuses.

### BACKGROUND

The Society of Automotive Engineers (SAE) has defined automation levels for automated vehicle systems that include capabilities such as execution of steering, acceleration and deceleration, monitoring of the driving environment, fallback performance of dynamic driving tasks and system capability defined by driving modes such as conditional automation, high automation and full automation (SAE Level 5). In SAE Level 5 automation, an automated driving system performs all aspects of the dynamic driving task under all roadway and environment conditions that can be managed by a human driver. Existing automated driving systems are based on in-vehicle artificial intelligence (AI) systems. However, SAE Level 5 is not achievable with existing in-vehicle AI systems.

### BRIEF DESCRIPTION OF THE DRAWINGS

FIG. 1 is a diagram of a roadway with an automated vehicle control distributed network in accordance with various embodiments.

FIG. 2 is a diagram of a roadway as in FIG. 1 and showing an automated vehicle in communication with the automated vehicle control distributed network in accordance with various embodiments.

FIG. 3 is a diagram showing various automated vehicles in communication with the automated vehicle control distributed network.

FIG. 4 is a diagram of a node in accordance with various embodiments.

FIG. 5 is a diagram of a pavement marker in accordance with various embodiments.

FIG. 6 is a diagram of a roadway showing automated vehicles in communication with the automated vehicle control distributed network and with each other in accordance with some embodiments.

FIG. 7 is a diagram of a roadway showing automated vehicles handovers to various nodes of an automated vehicle control distributed network in accordance with some embodiments.

FIG. 8 is a diagram of a node processor operative for 100×enhanced pattern recognition of objects on a roadway in accordance with an embodiment.

FIG. 9 is a flow chart showing a method of operation of an automated vehicle control distributed network in accordance with various embodiments.

FIG. 10 is a flow chart showing a method of operation of an automated vehicle control distributed network in accordance with various embodiments.

FIG. 11 is a flow chart showing a method of operation of an automated vehicle control distributed network in accordance with various embodiments.

FIG. 12 is a flow chart showing a method of operation of automated vehicle handover between roadside nodes in accordance with various embodiments.

FIG. 13 is a flow chart showing a method of operation of an automated vehicle control distributed network in accordance with various embodiments.

FIG. 14 is a diagram showing various emergency vehicles along with automated vehicles in communication with the automated vehicle control distributed network.

FIG. 15 is a diagram showing an engineering vehicle, or other service vehicle, along with various automated vehicles in communication with the automated vehicle control distributed network.

FIG. 16 is a flow chart showing a method of operation of an automated vehicle control distributed network in accordance with various embodiments.

FIG. 17 is a flow chart showing a method of operation of an automated vehicle control distributed network in accordance with various embodiments.

FIG. 18 is a flow chart showing a method of operation of an automated vehicle control distributed network in accordance with various embodiments.

FIG. 19 is a flow chart showing a method of operation of an automated vehicle control distributed network in accordance with various embodiments.

FIG. 20 is a flow chart showing a method of operation of an automated vehicle control distributed network in accordance with various embodiments.

### DETAILED DESCRIPTION

Briefly, the present disclosure provides an automated vehicle control distributed network that enables a full-automation, automated driving system that performs all aspects of dynamic driving tasks under all roadway and environment conditions without any interaction or control by a human driver. The disclosed automated vehicle control distributed network enables evolution from SAE Level 2 automation to SAE Level 5 automation.

The disclosed automated vehicle control distributed network enables detection of environment surrounding a vehicle including, but not limited to, surrounding object speed, location and direction. Such surrounding objects may include, but are not limited to, humans, animals, construction vehicles, other vehicles, etc. All road conditions are detected in three dimensions (3D) including, but not limited to, potholes, ice, other objects, etc.

The present disclosure provides an automated vehicle control distributed network node, that includes at least two modems for communicating with two neighboring roadside nodes on the same side of the roadway: at least one antenna for communicating with vehicles via a wireless connection: pattern recognition processing operative to detect patterns using image data from a plurality of high speed, high resolution video cameras that include night vision; vehicle prediction processing, operatively coupled to the pattern recognition processing, operative to predict vehicle location, velocity and direction using the pattern recognition processing; and a vehicle controller, operatively coupled to the vehicle prediction processing to receive vehicle prediction data, and to the at least one antenna, operative to send acceleration, deceleration and steering control signals to a plurality of vehicles in response to vehicle prediction data received from the vehicle prediction processing. The disclosed automated vehicle control distributed network enables evolution from SAE Level 2 automation to SAE Level 5 automation.

In some embodiments, the automated vehicle control distributed network node may include at least one high-speed high-resolution video cameras that include night vision, operatively coupled to the pattern recognition processing. The automated vehicle control distributed network node may further include at least a third modem for communicating with a third neighboring node across the roadway. The automated vehicle control distributed network node may further include a radio, distributed core network and vehicle processing, operatively coupled to the at least two modems, to the at least one antenna, and to the vehicle controller. The vehicle prediction processing may be implemented using a machine learning algorithm.

The present disclosure also provides an automated vehicle control distributed network, that includes a plurality of operatively coupled automated vehicle control distributed network nodes.

In some embodiments, the pattern recognition processing is further operative to detect missed points from the node image using image data from a neighboring node's cameras. The radio, distributed core network and vehicle processing may include a 4th generation (4G) and (5th generation) (5G) radio access component and associated distributed 4G and/or 5G core networks.

The present disclosure provides a method of operation that includes: obtaining high speed, high resolution video data from a plurality of roadway cameras; determining vehicle location, direction and velocity for at least one vehicle using the high speed, high resolution video data; predicting position of the at least one vehicle; and sending acceleration, deceleration and steering commands to the vehicle based on the predicted position.

The method may further include obtaining the high speed, high resolution video data from at least one camera, mounted on a plurality of roadside poles, to obtain a three-dimensional image with timestamps. The method may further include performing image correction on the three-dimensional image to generate a corrected image; and determining vehicle location, direction and velocity for at least one vehicle using the corrected image. The method may further include sending the acceleration, deceleration and steering commands to a plurality of vehicles as unicast Internet protocol (IP) packets. The method may further include sending acceleration, deceleration and steering commands to a plurality of vehicles as multicast Internet protocol (IP) packets. The method may further include obtaining environmental data from a plurality of environmental sensors. The method may further include obtaining environmental data from a plurality of environmental sensors via a pavement marker that has the plurality of environmental sensors and a transponder, by communication with the transponder.

The present disclosure provides a method of operation that includes: monitoring a roadway using a plurality of roadway high speed, high resolution cameras to detect vehicles, animals, pedestrians, road anomalies and impediment objects; creating a prediction model for each detected vehicle, animal, pedestrian, road anomaly and impediment object; determining control actions for at least one vehicle based on at least one prediction model; and sending acceleration, deceleration and steering commands to the at least vehicle one based on the determined control actions. The method may further include receiving control feedback via the plurality of roadway high speed, high resolution cameras for the at least one vehicle; and sending adjusted acceleration, deceleration and steering commands to the at least vehicle one based on the control feedback.

The method may further include maintaining a plurality of wireless connections between the at least one vehicle and an automated vehicle control distributed network via a plurality of roadside nodes; and performing continuously a make before break wireless handoff to at least one additional roadside node by the at least one vehicle as the at least one vehicle travels along a roadway such that there is no communication delay between the at least one vehicle and the automated vehicle control distributed network. The method may further include sending the adjusted acceleration, deceleration and steering commands to the at least vehicle redundantly using the plurality of roadside nodes.

The present disclosure also provides a method of operating an automated vehicle control distributed network comprising: detecting an emergency vehicle on a roadway; creating a prediction model for the emergency vehicle; and sending control commands to vehicles within a distance in front of the emergency vehicle to clear a path for the emergency vehicle based on the prediction model.

The method may further include detecting the emergency vehicle on the roadway using a plurality of roadway high speed, high resolution cameras. The method may further include determining an emergency vehicle location, direction and velocity using high speed, high resolution video data from the high speed, high resolution cameras. The method may further include sending control commands comprising acceleration, deceleration and steering commands. The method may further include sending control commands as multicast Internet protocol (IP) packets. The method may further include sending control commands to vehicles in front of the emergency vehicle within a distance of less than or equal to one mile in front of the emergency vehicle. The method may further include continuing to send control commands to vehicles in front of the emergency vehicle until the emergency vehicle is determined to be stationary by the automated vehicle control distributed network. The method may further include detecting a turn signal of the emergency vehicle. The method may further include sending control commands to vehicles in front of the emergency vehicle initiating a lane change based on the turn signal of the emergency vehicle.

Another disclosed method of operating an automated vehicle control distributed network includes: detecting an emergency vehicle on a roadway; determining that the emergency vehicle is stationary; and sending control commands to vehicles approaching the emergency vehicle to reduce speed as the vehicles approach the emergency vehicle.

The method may further include detecting the emergency vehicle on the roadway using a plurality of roadway high speed, high resolution cameras. The method may further include determining an emergency vehicle location using high speed, high resolution video data from the high speed, high resolution cameras. The method may further include sending control commands to vehicles approaching the emergency vehicle to initiate a lane change prior to the vehicles passing the emergency vehicle. The method may further include sending control commands comprising deceleration and steering commands. The method may further include sending control commands as multicast Internet protocol (IP) packets.

Another disclosed method of operating an automated vehicle control distributed network includes: detecting a service vehicle on a roadway: detecting a sign indication on the service vehicle indicating a direction of movement; and sending control commands to vehicles within a distance behind the service vehicle to a path in accordance with the direction indicated by the sign direction.

The method may further include detecting the service vehicle on the roadway using a plurality of roadway high speed, high resolution cameras. The method may further include determining a service vehicle location using high speed, high resolution video data from the high speed, high resolution cameras. The method may further include detecting the sign indication on the service vehicle indicating a direction of movement, using a plurality of roadway high speed, high resolution cameras. The method may further include sending the control commands to vehicles as multicast Internet protocol (IP) packets.

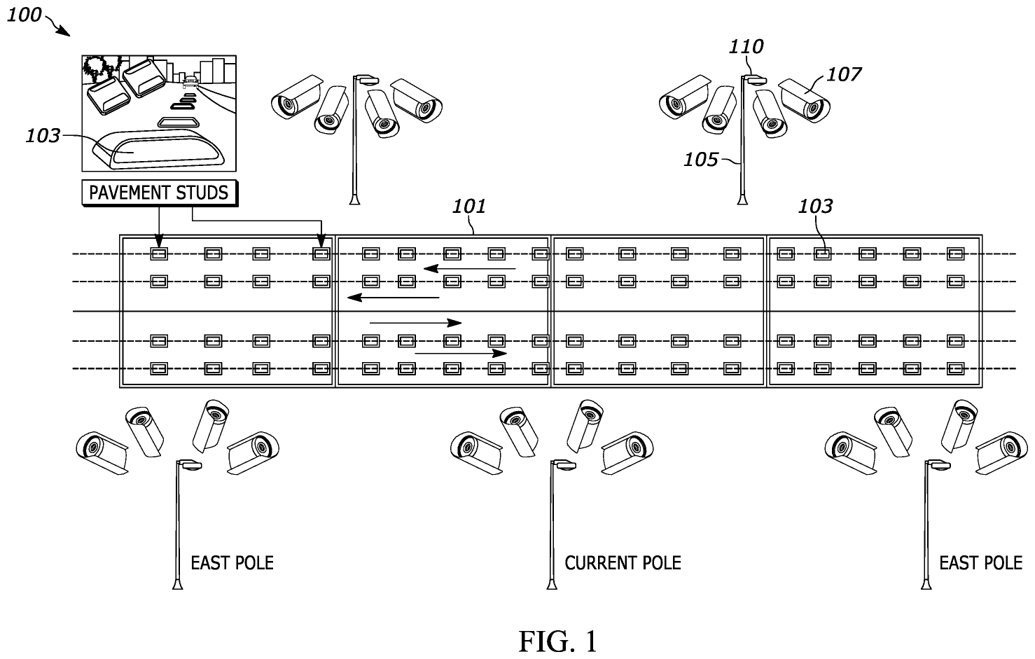

Turning now to the drawings wherein like numerals represent like components, FIG. 1 illustrates an automated vehicle control distributed network 100 in accordance with various embodiments. The automated vehicle control distributed network 100 is one type of disclosed apparatus in accordance with various embodiments. The roadway 101 includes pavement markers 103 (or pavement studs) that contain a transponder component such that they may communicate information to various other components of the automated vehicle control distributed network. The transponder may be, for example, radio frequency identification (RFID) or an equivalent transponder communication capability.

The automated vehicle control distributed network includes various poles 105 or towers located at points along both sides of the roadway 101. Each pole 105 includes a set of mounted high speed (i.e., for example, at least 60 fps) high resolution video cameras 107 that include night vision, and a node 110. The cameras 107 of each pole are operatively coupled to, and communicate with, the node 110. The camera 107 view angles are arranged such that they overlap each other with respect to each camera's view along the road. For example, a right-most camera's view on any given pole 105 is arranged such that its view overlaps that of the left-most camera on the pole 105, etc.

In one embodiment, all views of cameras 107 on a pole 105 are combined as one frame of, for example, one long high-resolution rectangle, or a trapezoidal shape. The various camera 107 views cover both sides of the roadway 101. In one embodiment, the multi-camera 107 image may be corrected using keystoning (i.e. applying a keystone correction algorithm) such as by using optical trapezoid correction, digital trapezoid correction or a combination etc. The image processing utilized is 3D image processing and 4D images are generated using frame time stamps. All views of the cameras 107 extend beyond the roadway 101 such that non-vehicle objects are captured such as animals, pedestrians, roadway deformities such as potholes/sinkholes, pavement cracks, pavement buckling, etc. The location of the poles 105 on opposite sides of the road are offset at the midpoint as shown in FIG. 1.

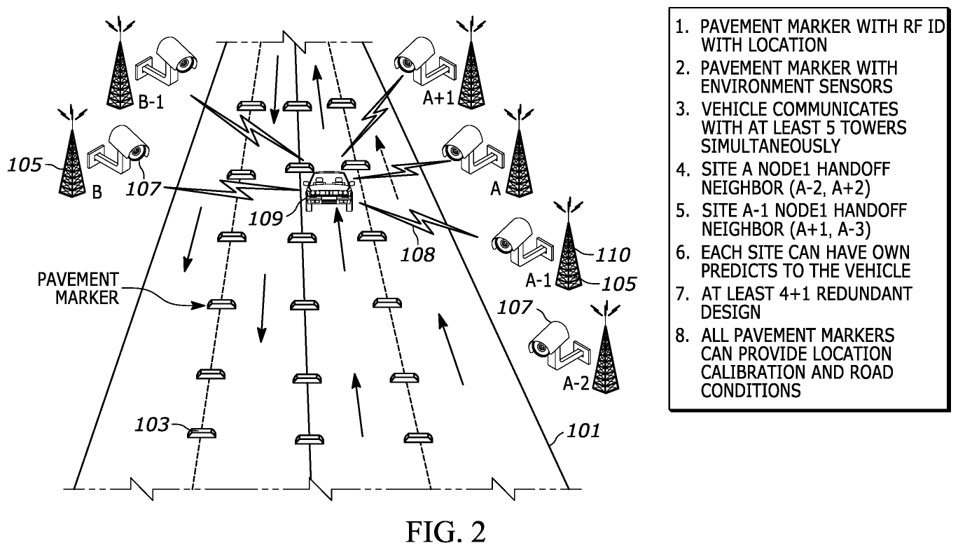

FIG. 2 is a block diagram of a roadway as in FIG. 1 and showing an automated vehicle 109 in communication with the automated vehicle control distributed network 100 via multiple wireless links 108 in accordance with various embodiments. The automated vehicle control distributed network 100 is operative to recognize each vehicle 109 based upon certain unique points (16, 32, 48, etc.) In some embodiments, if the vehicle 109 make, model, color and license plate number can be detected, then the automated vehicle control distributed network 100 may check a database to get the vehicle size, year, or other information, etc. Otherwise, the automated vehicle control distributed network 100 is operative to use pattern recognition and a database to obtain the vehicle make, model, color, size and year info, etc. by, for example, using the license plate number as an ID of the vehicle. Vehicles that are not automated are also detected by the automated vehicle control distributed network 100 and information may also be retrieved from a database using the same criteria. The transponder enabled pavement markers 103 can be passive or battery active transponders.

The transponder enabled pavement markers 103 are operative to communicate with the nodes 110, and are used by the nodes 110 to calibrate location and provide roadway 101 condition updates such as temperature, moisture, etc. Each pavement marker 103 may therefore also include various environmental sensors such as, but not limited to, temperature, moisture, pressure, etc. Because the roadway 101 expands and contracts with temperature, and may also buckle or have potholes, cracks, or other deformities that may occur such that the precise location of the pavement markers 103 will change periodically over time. Based on pavement marker 103 geo-information detected by the various nodes 110, the automated vehicle control distributed network 100 is operative to recalibrate each location periodically to ensure accuracy.

Vehicle 109 direction and speed is calculated by the nodes 110 for each vehicle 109 using the vehicle 109 ID as detected in adjacent video images and corresponding time stamps. In one example of operation on a roadway with an east-west direction, all vehicle IDs traveling in an east-bound direction will pass and be identified by all adjacent and opposite nodes 110 along the roadway 101 in the east-bound direction and on both sides of the road. This likewise occurs for all west-bound vehicles with respect to adjacent and opposite nodes 110 along the roadway 101 in the west-bound direction.

Each automated vehicle 109 communicates with at least five nodes 110 in a simultaneous manner and performs a radio handoff of at least one of the wireless links 108 from one node 110 to another as it travels such that communication with at least five nodes 110 is always maintained. In other words, a 4+1 wireless link 108 redundancy is maintained. Vehicle control commands such as, but not limited to, acceleration, deceleration and steering commands, can be sent to a vehicle redundantly via each or the redundant wireless links, increasing control command reliability. In one example of a radio handoff operation, the vehicle 109 may initially communicate with node A−2 on the right-most side of the roadway 101 and initiate radio handoff with node A+1 as it travels in the direction of travel arrow shown in FIG. 2. In other words, the vehicle 109 maintains multiple wireless connections with multiple nodes and continuously performs make-before-break radio handoffs as the vehicle 109 travels along a roadway. Each node 110 performs its own prediction of vehicle 109 location and can share this information with each of the other nodes 110. In other words, each node 110 operates independently from other nodes 110 in the distributed network and each node 110 is operative to perform pattern recognition and apply artificial intelligence or machine learning to create a prediction model for a vehicle's location, direction and velocity (and also for non-automated vehicles, unregistered vehicles, other objects, pedestrians, animals, and road deformities) and to send control signals including acceleration, deceleration and steering. The nodes 110 communicate to share data, models, and processing power if needed and thereby enhance redundancy for all automated vehicles. Each node 110 in the distributed network is also operative to gather training data that is used to train machine learning/AI algorithms such as, but not limited to, the pattern recognition and vehicle prediction processing such that these and other machine learning/AI algorithms may be initially trained as well as enhanced by additional collected big data.

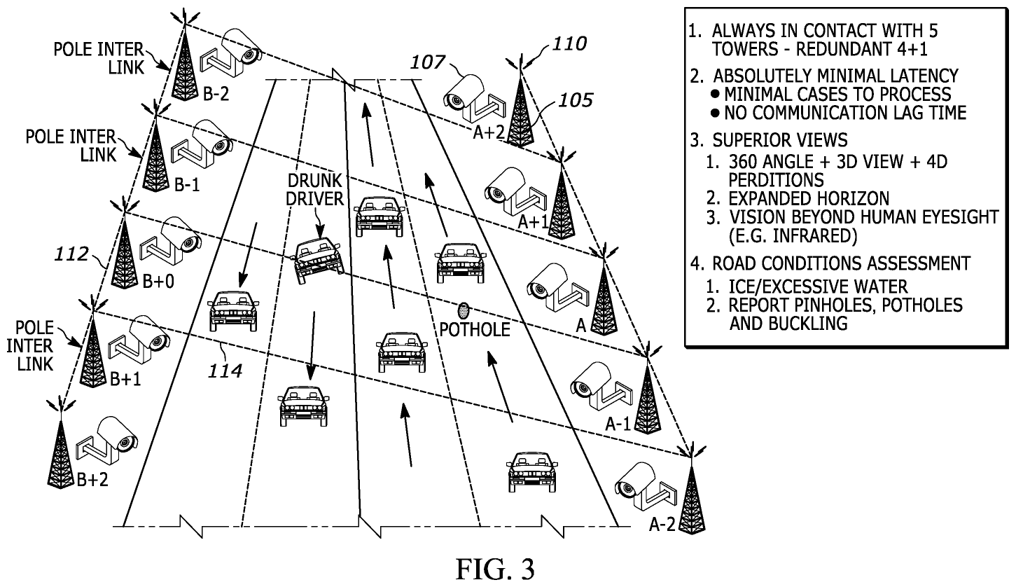

FIG. 3 is a diagram showing a roadway and showing interaction of various automated vehicles with the automated vehicle control distributed network 100 in accordance with various embodiments. Each of the nodes 110 in the automated vehicle control distributed network 100 perform pattern recognition from their respective video images and are operative to identify animals in the area, humans in the area, road changes such as potholes or buckling, motorcycles between lanes, oversized truck loads, etc. Detected objects are modeled at the nodes 110 and stored in databases by at least 16 points including size, weight, maximum speed, hardness, etc. Each modeled object is assigned a unique ID in the originating node 110 and the assigned ID is passed from the originating node 110 to adjacent nodes 110 via wireless or wired communication links 112 between the nodes 110.

Each node 110 is provides a fully distributed network function (Network Function Virtualization—NFV), and contains a 4G/5G radio and core network functions in a 1:1 ratio. Each pole 105 in the automated vehicle control distributed network 100 includes at least one node 110. Each node 110 has its own neighbor list for handovers however the neighbor list does not contain its adjacent node 110. Instead, the neighbor list contains the second adjacent node 110. In one example of handoff groups between nodes 110, a handoff group 1 is Node (2n), n=1, 2, 3, . . . . M; and handoff group 2 is Node (2n+1), n=1, 2, 3, . . . . M. The handoff group1 is set to the same frequency of a first wireless channel and the handoff group 2 is set to the same frequency of a second wireless channel.

Node-to-node communication links include same roadside communication links 112 and crossroad communication links 114 such that a grid or mesh is formed. The communication links 112 and communication links 114 between the nodes 110 may be wired, wireless or a combination of both wired and wireless communication links. The wireless or wired communication links 112 and communication links 114 are set up in the mesh configuration as shown to enable redundancy. Adjacent and opposite nodes 110 are linked. Each node 110 collects all IDs of vehicles and objects within its visual detection area as well as vehicle and object IDs of each neighbor node 110.

For example, in FIG. 3, node A will have all IDs for vehicles and objects it has identified as well as for node A+1, A−1, B, and B−1. All IDs and associated information are combined as one package and include object size, weight, speed, direction, current location, type, time stamp, score, etc. Relevant objects are also assigned a danger score. Road deformities such as detected potholes are assessed for size of the pothole and depth. For vehicles, recent vehicle driving history is evaluated. For example, drunk or reckless driving detected by the pattern recognition is flagged. All vehicle and object IDs and information including vehicle driving direction is passed to each adjacent node on both sides along the roadway. All vehicles on the roadway are tracked, including those that are not receiving control signals (i.e. not registered on the automated vehicle control distributed network 100) and those that are not automated vehicles.

The node 110 to node 110 communication is performed using Internet protocol (IP) packets and also to all automated vehicles that are registered in the automated vehicle control distributed network 100. IP packets may be delivered via broadcast, unicast or multicast as determined by the situation. For example, unicast Internet protocol (IP) packet delivery is used to directly control the vehicles. Driving instructions are based upon identified dangers, road conditions, and vehicle speeds and locations in the vicinity of the registered vehicle. Braking, acceleration and steering control signals may be based on this identified danger information, and transmitted to multiple vehicles using broadcast packets.

Multicast IP packet capabilities may be used for fleet vehicle control. For example, weather conditions may warrant that a message be sent to a truck fleet to establish a maximum speed. The multicast users also receive the broadcast packets. Broadcast IP packets are used to provide information to all registered vehicles to provide assistance information such as information on 3D sizes, moving direction, speed of all objects (vehicles, animal, human) for a current pole node 110 and its neighbor nodes. Data updates in the system occurs as fast as 20 milliseconds.

In one embodiment, efficient pattern recognition is achieved using the least squares method. In an example of capturing a vehicle with 8 xyz points, then comparing to a model of 8 XYZ points a score=sqrt[(x₁−X₁)²+(y₁−Y₁)²+(z₁−z₁)²]+ . . . +sqrt[(x₂−X₂)²+(y₂−Y₂)²+(z₁−Z₁)²]+ . . . +sqrt[(x₈−X₈)²+(y₈−Y₈)²+(z₈−Z₈)²] such that the lowest score will be the model. The node 110 processor is specially designed for up to 64-point least square methods and uses a logarithm algorithm to greatly reduce the multiple, divide, square, square root operations.

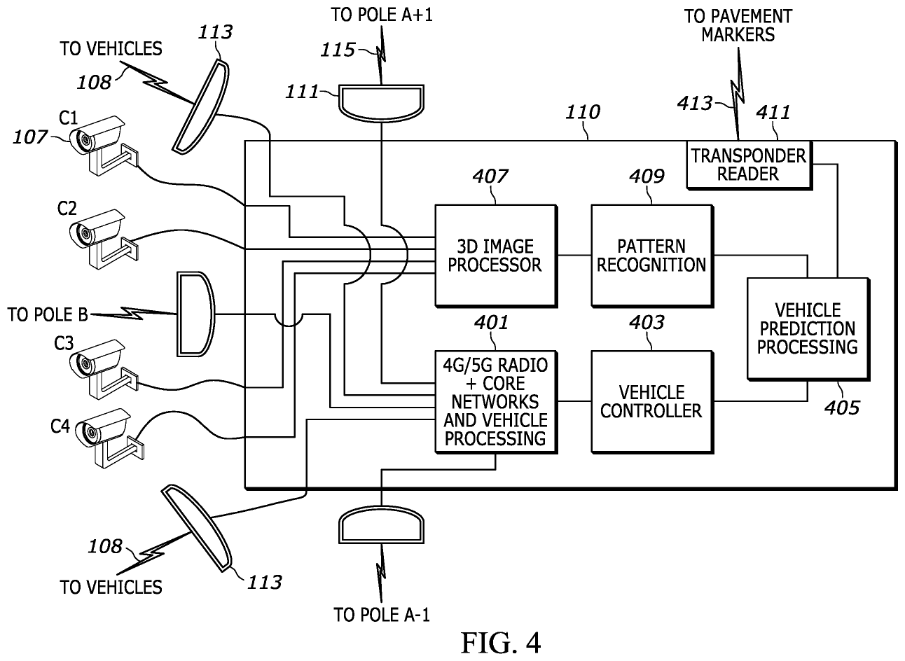

FIG. 4 is a diagram of a node 110 in accordance with various embodiments. The automated vehicle control distributed network node 110 is one type of disclosed apparatus in accordance with various embodiments. Each node 110 includes cellular antennas 113 for communication with vehicles via the wireless links 108, and for sending control signals to the vehicles. The cellular antennas 113 may be antenna arrays and may be multiple-input and multiple-output (MIMO) antenna arrays. At least three modems 111 provide communication to neighboring adjacent nodes via a wireless communication link 115 or via a wired communication link or by a combination of both. As with wireless links 108, the wireless communication links 115 may be facilitated using MIMO antenna arrays in some embodiments. Cameras C1 through C4 are operatively coupled to the node 110 and to 3D image processing 407. The 3D image processing 407 feeds into pattern recognition 409 which, in turn, provides pattern recognition data to vehicle prediction processing 405.

A transponder reader 411 is operative to communicate with pavement marker 103 transponders via wireless link 413, to obtain environmental sensor data. The environmental sensor data is provided to the vehicle prediction processing 405 via operative coupling.

The node 110 may include any number of modems 111 and FIG. 4 is one example in which three modems 111 are present in the node 110. The three modems 111 are operatively coupled to a radio (for example 4G/5G) 4G/5G distributed core network and vehicle processing 401 which is further operatively coupled to a vehicle controller 403.

The vehicle controller 403 is operatively coupled to the vehicle prediction processing 405. Object identification and prediction data generated by the pattern recognition 409 and vehicle prediction processing 405 is shared with neighbor nodes via the wireless communication link 115 using the modems 111. The vehicle prediction processing 405 is operatively coupled to a vehicle controller 403 and is operative to communicate road conditions and object information. The vehicle prediction processing 405 and vehicle controller 403 are configured as a feedback system in which the vehicle prediction processing 405 detects vehicle position changes occurring in response to vehicle control signals send via the vehicle controller 403.

The vehicle controller 403 is operative to control vehicles by sending acceleration, deceleration and steering control signals over the wireless links 108 using the 4G/5G radio and 4G/5G distributed core network and vehicle processing 401. The 4G/5G radio and 4G/5G distributed core network and vehicle processing 401 is operatively coupled to the cellular antennas 113 to send the vehicle control signals over wireless links 108. The 4G/5G radio and 4G/5G distributed core network and vehicle processing 401 includes a 4G/5G radio and embedded distributed core network functions that enable the node 110 to operate as an independent entity in the distributed network such that, if other nodes 110 become disabled or are otherwise unavailable, full automated vehicle control is uninterrupted.

The various processing/processors in the node 110 may be implemented as System-on-a-Chip (SoC) systems and may include hardware, firmware and software to perform the various functions of the node 110.

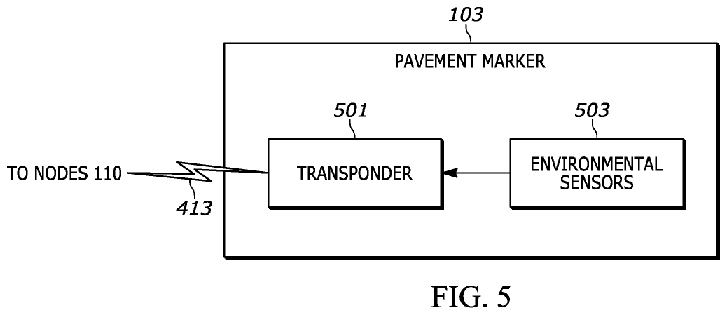

FIG. 5 is a diagram of an example pavement marker 103 in accordance with various embodiments. The pavement marker 103 is one type of disclosed apparatus in accordance with various embodiments. The pavement marker 103 includes a transponder, which may be an RFID transponder, and environmental sensors that are operatively coupled to the transponder 501. The nodes 110 may extract environment sensor 503 data via communicating with the transponder 501. The environmental sensors may include, but are not limited to, temperature, moisture, pressure, inertia, etc.

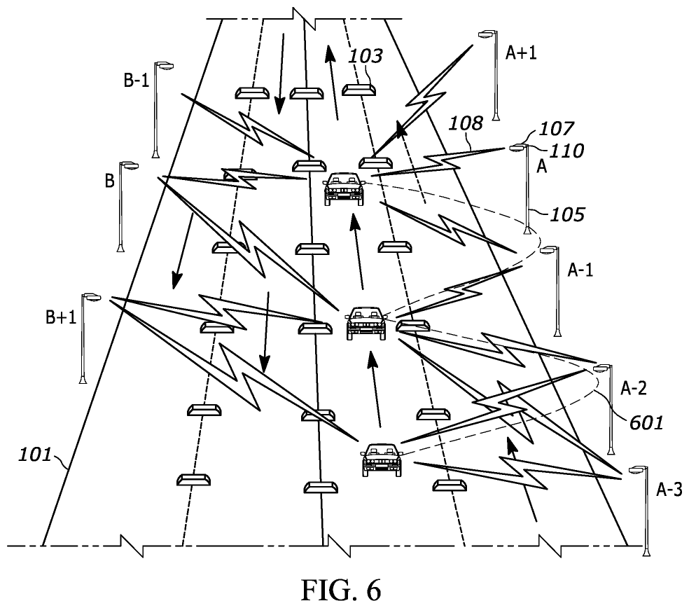

FIG. 6 is a block diagram of a roadway 101 and showing automated vehicles in communication with the automated vehicle control distributed network 100 and with each other in accordance with some embodiments. Vehicle-to-vehicle communication 601 may be facilitated by the same pole 105 and node 110 or by adjacent poles/nodes. In some embodiments, each vehicle has 4+1 redundant links for reliability.

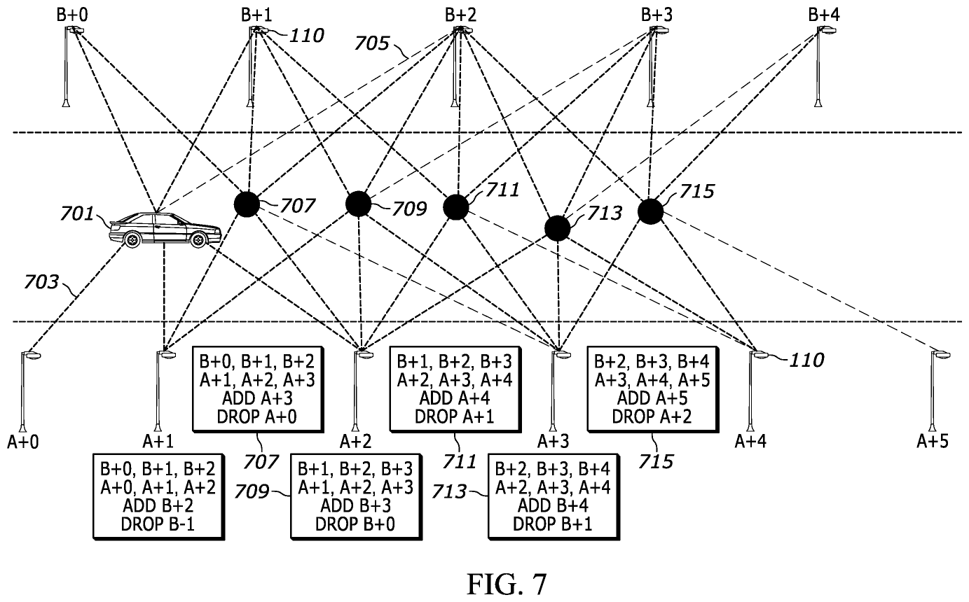

FIG. 7 is a diagram illustrating an automated vehicle 701 performing handovers to various nodes 110 of an automated vehicle control distributed network 100 along a roadway in accordance with some embodiments. The automated vehicle 701 maintains multiple wireless connections 703 with at least four nodes 110 at any given time and performs a make-before-break handover operation to additional upcoming nodes 110 as it moves along its travel path. In the example of FIG. 7, the automated vehicle 701 is initially in communication with five nodes: A+0, A+1, A+2, B+0, and B−1 (not shown). At the automated vehicle 701 current location it has established a new connection 705 with node B+2 and has dropped a previous connection with node B−1. As the automated vehicle 701 moves along the roadway to location 707, a make-before-break connection 705 is established with node A+3. Subsequent to establishing the node A+3 connection, the node A+0 connection is dropped. Moving to location 709, the automated vehicle 701 then establishes a connection to node B+3 and drops a connection to node B+0. Prior to location 711 the automate vehicles adds a connection to node A+4 and drops the connection to A+1. Prior to location 713 it adds a connection to node B+4 and drops the connection to node B+1. Prior to location 715 it adds a connection to node A+5 and drops the connection to node A+2, etc.

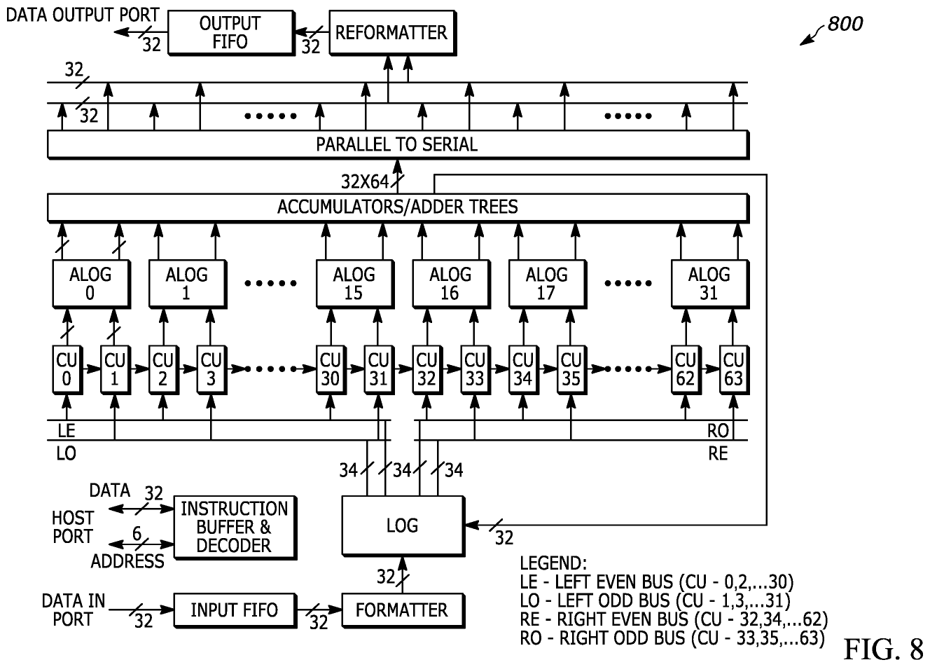

FIG. 8 is a diagram of a node processor 800 in accordance with an embodiment. The node 110 processor 800 may perform the 3D image processing 407 and pattern recognition 409 and is specially designed for up to 64-point least square methods and uses a logarithm algorithm to greatly reduce the multiple, divide, square, square root operations. In some embodiments, the node processor 800 may also be used to implement the vehicle prediction processing 405, vehicle controller 403, the 4G/5G+core networks and vehicle processing 401 or some combination of these. The 4G/5G+core networks and vehicle processing 401, vehicle controller 403, vehicle prediction processing 405, 3D image processor 407, and/or pattern recognition 409, may each be implemented as one or more microprocessors, ASICs, FPGAs, microcomputers, microcontrollers, digital signal processors, central processing units, state machines, logic circuitries, and/or devices that manipulate signals based on operational instructions. Among other capabilities, one or more of the processors used to implement the node 110 is configured and operative to fetch and execute computer-readable instructions (i.e. executable instructions) stored in the memory (not shown) which may be separate non-volatile, non-transitory memory within the node 110 and/or on-board memory that is part of a SoC configuration or a combination of both. Regardless of specific implementations of the 4G/5G+core networks and vehicle processing 401, vehicle controller 403, vehicle prediction processing 405, 3D image processor 407, and pattern recognition 409, each component is operatively coupled to communicated inputs and outputs as shown in FIG. 4 and are operable to execute any associated software and/or firmware including any required APIS (application programming interfaces) between such components. The 4G/5G+core networks and vehicle processing 401 includes any needed wireless baseband hardware and software and is operative to execute an Internet Protocol (IP) stack and form multiple wireless IP connections with vehicles as well as with other nodes in order to share information, to send control commands and to receive feedback information. The 4G/5G+core networks and vehicle processing 401 is a fully network infrastructure/architecture including all necessary 4G/5G radio and core network components/entities required to implement 4G/5G operational functions including maintaining redundant radio wireless links with controlled vehicles and implementing make-before-break radio handoffs for multiple vehicles.

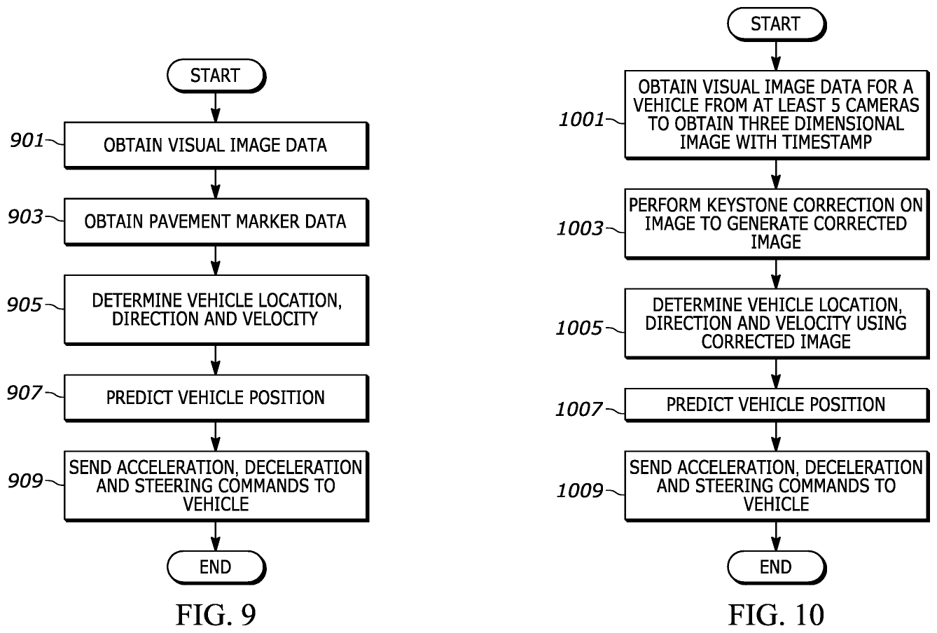

FIG. 9 is a flow chart showing a method of operation of an automated vehicle control distributed network 100 in accordance with various embodiments. The method of operation begins, and in operation block 901 a node 110 of the automated vehicle control distributed network 100 obtains visual image data of a roadway. The visual image data captures vehicles as well as pedestrians, animals, objects in the roadway, and deformities in the pavement among other things. In operation block 903, the node 110 obtains environmental sensor data from the pavement markers 103. In operation block 905, the node 110 determines vehicle location, direction and velocity for a plurality of vehicles on the roadway. In operation block 907, the node 110 predicts vehicle position for all vehicles registered with the automated vehicle control distributed network 100. In operation block 909, the node 110 sends acceleration, deceleration and steering control signals to each registered vehicle.

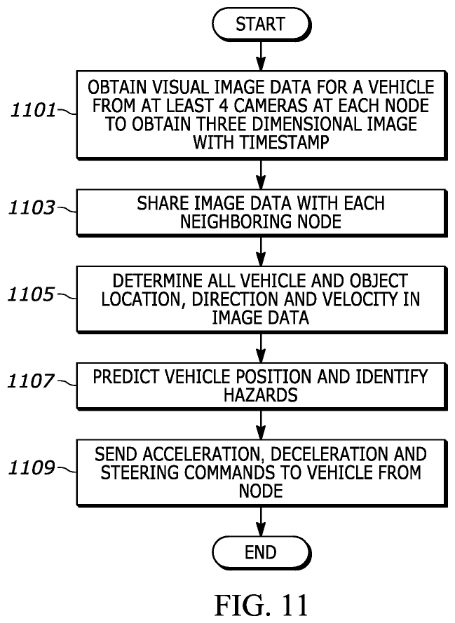

FIG. 10 is a flow chart showing a method of operation of an automated vehicle control distributed network in accordance with various embodiments. The method of operation begins, and in operation block 1001 a node 110 of the automated vehicle control distributed network 110 obtains visual image data for vehicles from at least five cameras to obtain a three-dimensional image with timestamps per frame. In operation block 1003, the node 110 performs Keystone correction on the images to generate corrected images. In operation block 1005, the node 110 determines vehicle location, direction and velocity using the corrected images. In operation block 1007, the node 110 predicts vehicle position. In operation block 1009, the node 110 sends acceleration, deceleration and steering control signals to the vehicle.

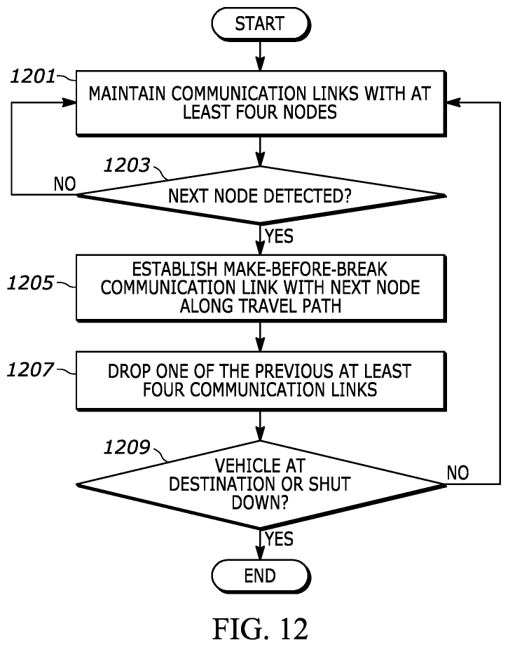

FIG. 11 is a flow chart showing a method of operation of an automated vehicle control distributed network in accordance with various embodiments. The method of operation begins, and in operation block 1101, visual image data is obtained for a vehicle from multiple roadway nodes 110 with at least four cameras in each node to obtain three-dimensional image data with timestamps for each frame, in operation block 1103, each node 110 shares its image data with each neighboring node. In operation block 1105, each node 110 determines all vehicle object location, direction and velocity in its image data. In operation block 1107, each node 110 predicts vehicle position and identifies hazards that may be present in the roadway. In operation block 1109, a node 110 sends of acceleration, deceleration and steering control signals to the vehicle from the node 110.

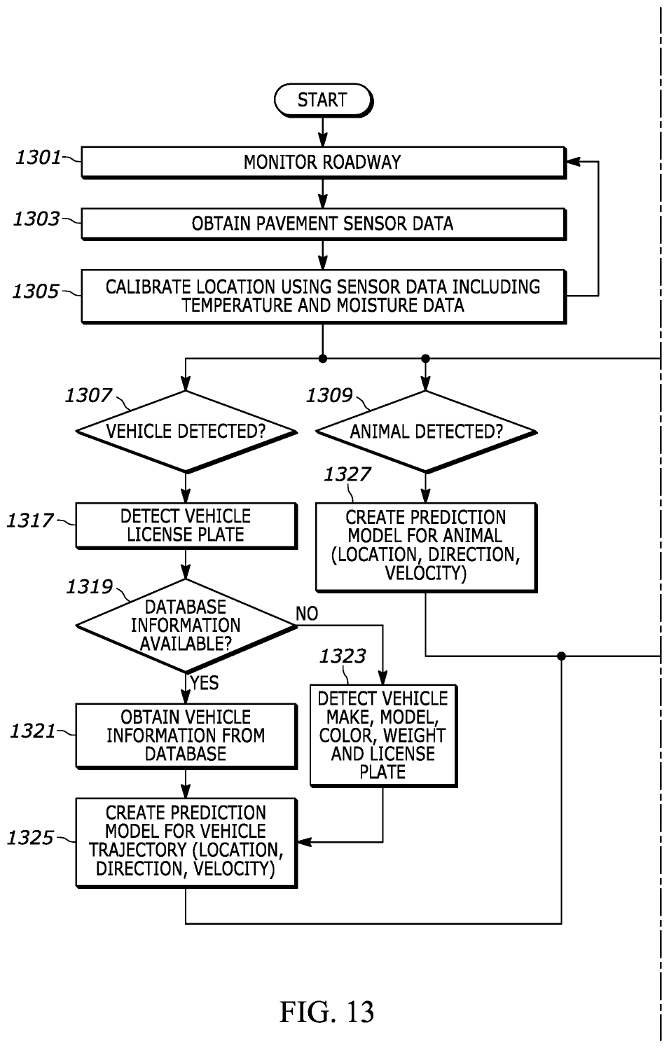

FIG. 12 is a flowchart showing a method of operation of automated vehicle handover between roadside nodes as illustrated in FIG. 7 in accordance with various embodiments. The process begins where an automated vehicle is traveling on a roadway and establishes and maintains a wireless communication link with at least four nodes as in operation block 1201. As the automated vehicle travels and passes additional roadside nodes 110, an increase in RSSI (Received Signal Strength Indicator) occurs as observed by the automated vehicle. Also, the RSSI of the automated vehicle increases as perceived by the radio transceivers of nodes 110 being approached by the automated vehicle. Thus, in decision block 1203, the automated vehicle may detect a next node by, for example, using a threshold RSSI value or some other communication link metric. In other words, RSSI is only one example metric and any other suitable communication link metric may be used for next node detection such as, but not limited to, bit error rate, frame error rate, frame erasure rate or some other metric, etc. Until a candidate next node meets the threshold metric requirement, the existing at least four wireless communication links are maintained in operation block 1201. Upon a next node candidate appearing in decision block 1203, the automated vehicle will establish a new make-before-break communication link with the candidate node in operation block 1205. After the communication link has been established, then in operation block 1207 the automated vehicle can drop one of the previous at least four communication links. Usually, the communication link having the lowest metric will be dropped. However, the farthest node from the vehicle may be dropped by default in some implementation. In decision block 1209, if the vehicle has been shut down such as when it has stopped, or has otherwise reached its destination and is no longer moving, the process terminates. Otherwise, the process continues in a loop at operation block 1201 until the vehicle stops moving.

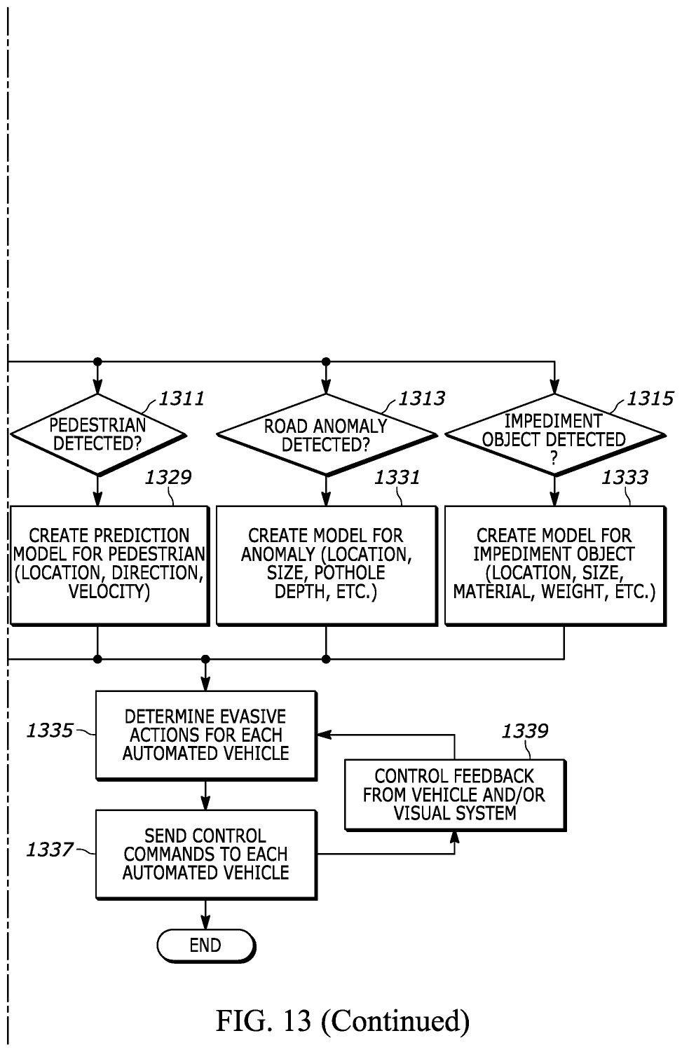

FIG. 13 is a flow chart showing a method of operation of an automated vehicle control distributed network in accordance with various embodiments. The method of operation begins and in operation block 1301 an automated vehicle control distributed network monitors all activity on a roadway. In operation block 1303 the automated vehicle control distributed network obtains sensor data from the pavement sensors via a wireless connection, and in operation block 1305 calibrates the pavement marker location using the sensor data. The sensor data may include, but is not limited to, temperature, moisture data, pressure data, etc.

The automated vehicle control distributed network then monitors all roadway activity including vehicles in decision block 1307, animals in decision block 1309, pedestrians in decision block 1311, road anomalies in decision block 1313, and impediment objects in decision block 1315. The process of each decision block continues indefinitely and continuously tracks all items on the roadway continuously.

If a vehicle is detected in decision block 1307, the automated vehicle control distributed network may detect the vehicles license plate in operation block 1317 and check the license plate number in a database in decision block 1319. Any vehicle information in the database is retrieved in operation block 1321. Otherwise, if there is no license plate on the vehicle or otherwise if no information is available in the database in decision block 1319, then in operation block 1323 the automated vehicle control distributed network will use the visual detection system to detect the vehicle make, model, color and weight. In operation block 1325 the automated vehicle control distributed network creates a prediction model using any database information and information from the visual detection system.

If an animal is detected in decision block 1309, then in operation block 1327 the automated vehicle control distributed network creates a motion prediction model for the animal. Likewise, if a pedestrian is detected in decision block 1311, then in operation block 1329 the automated vehicle control distributed network creates a motion prediction model for the pedestrian. If any road anomaly is detected in decision block 1313, then in operation block 1331 a model of the anomaly is created including features such as, but not limited to, location, size, pothole depth, etc. If an impediment object is detected in decision block 1315, then in operation block 1333, a model is created for the impediment including features such as, but not limited to, object size, material, weight, etc. to the extent detectable by the visual detection system in combination with information from the pavement sensors.

Based on all of the created prediction models, in operation block 1335 the automated vehicle control distributed network determines appropriate evasive action for each automated vehicle. Each automated vehicle is also modeled at operation block 1325. In operation block 1337 the automated vehicle control distributed network sends appropriate control commands to each automated vehicle in a coordinated manner such that all collisions are avoided. Feedback is obtained in operation block 1339 to make further course corrections for each automated vehicle.

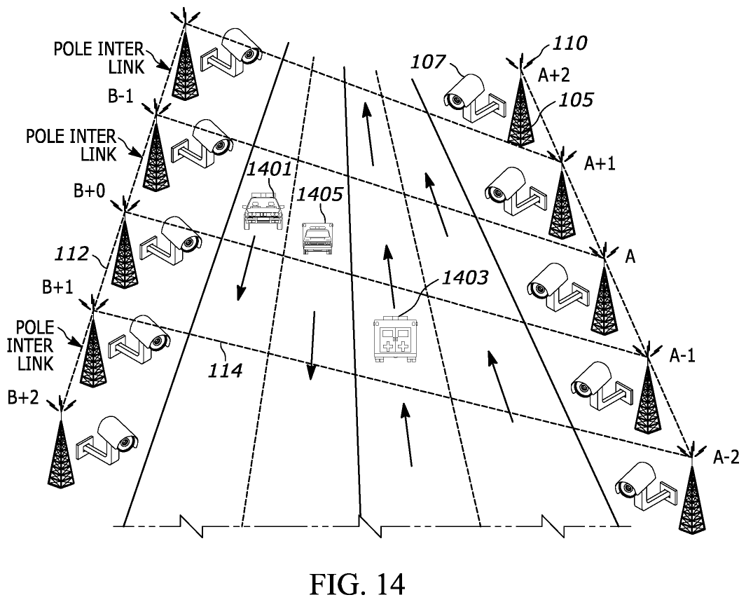

FIG. 14 is a diagram showing various emergency vehicles such as a police car 1401 and an ambulance 1403, along with automated vehicles in communication with the automated vehicle control distributed network. The disclosed apparatuses, systems and methods help vehicles comply with “move over” laws regarding emergency vehicles. Move over laws require drivers that are approaching police or other emergency vehicles to change lanes if possible, reduce speed and proceed with caution. One example move over law is the Illinois law referred to as “Scott's Law.” Scott's Law in Illinois was named in remembrance of Chicago Fire Department Lieutenant Scott Gillen, who was struck and killed by an intoxicated driver while he was assisting at a crash on the roadside of an expressway. Scott's Law defines an authorized emergency vehicle as including any vehicle authorized by law to be equipped with oscillating, rotating, or flashing lights, while the owner or operator of the vehicle is engaged in their official duties. Example emergency vehicles under the Illinois move over law include, police cars, fire trucks, ambulances, Illinois Department of Transportation (IDOT) vehicles, snowplows, etc.

In FIG. 3, the police car 1401 and ambulance 1403 are example emergency vehicles. The cameras 107 of the automated vehicle control distributed network 100 are capable of detecting the flashing lights of the vehicle and may also determine the vehicle type. The cameras 107 may also detect turn signals on the emergency vehicles. The emergency vehicles are treated as modeled objects, as described previously, and are each assigned a unique ID in the originating node 110 and the assigned ID is passed from the originating node 110 to adjacent nodes 110 via wireless or wired communication links 112 between the nodes 110. Each emergency vehicle's speed and direction (i.e. velocity) is determined and a predictive model is built. All vehicles with a given distance from the emergency vehicles, for example vehicle 1405 are send a broadcast signal with appropriate directions such as to move to the roadside and stop, change lanes, etc.

In one example operation, if the police car 1401 is moving in the direction indicated by the arrow 1402 in FIG. 14, then any vehicle in front of the police car 1401 within a distance, such as for example one mile, will be sent a broadcast signal causing the vehicle to move to the roadside and stop to enable the police car 1401 to pass safely. For example, the vehicle 1405 would be controlled to pull over to the shoulder of the roadway and stop to allow the police car 1401 to pass. Likewise, on the other side of the roadway in FIG. 14, any vehicle for a mile in front of the ambulance 1403 moving in the direction of the ambulance on the same portion of roadway would receive a broadcast signal to pull over to the shoulder of the roadway and stop to allow the ambulance to pass. The distance may be more or less than a mile in front of the emergency vehicle and the distance may also be determined by other conditions such as weather conditions, current traffic conditions, roadway conditions, etc.

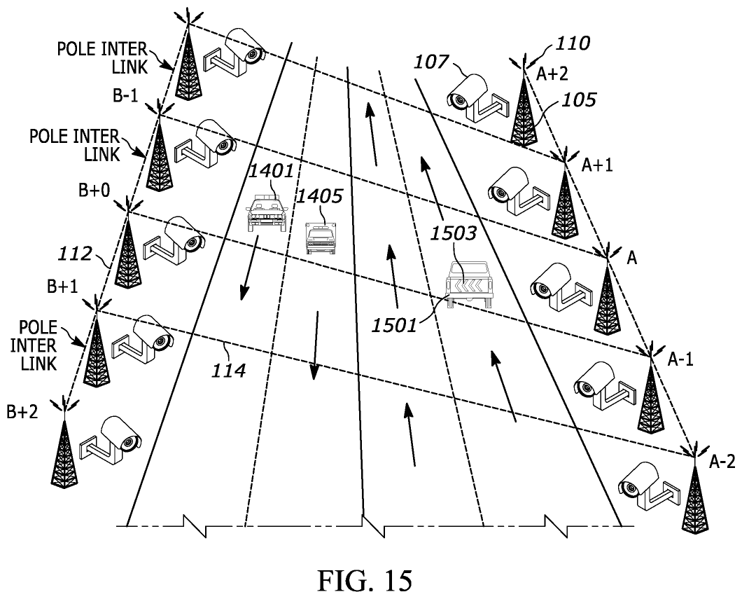

FIG. 15 illustrates a service vehicle 1501 having a sign indicator 1503 that provides an indication of direction such as “move left” or “move right.” The example sign indicator 1503 provides a “move left” indication of direction, directing oncoming traffic to move to the left of the service vehicle 1501. Move over laws of most states includes service vehicles in their definitions of “emergency vehicle.” As used herein, the term “service vehicle” refers to Department of Transportation vehicles, snowplows, tow trucks, engineering vehicles, department of forestry or animal control or other governmental vehicles. The term “emergency vehicle” as used herein refers to police, fire department, and medical/ambulance vehicles.

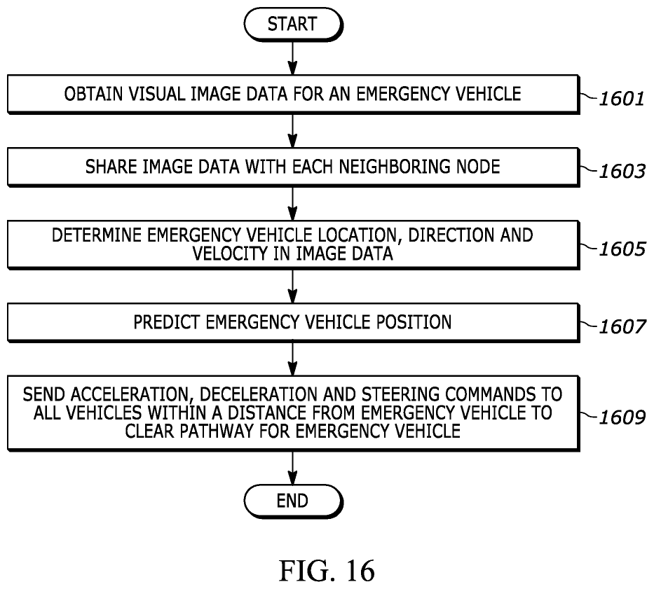

FIG. 16 is a flow chart showing a method of operation of an automated vehicle operation begins, and in operation block 1601 a node 110 of the automated vehicle control distributed network 100 obtains visual image data for an emergency vehicle on a roadway. The visual image data captures the flashing lights of emergency vehicles and may also detect the type of emergency vehicle such as police car, fire truck, or ambulance, etc. In operation block 1603, the node 110 shares the image data with neighboring nodes. In operation block 1605, the node 110 determines emergency vehicle location, and velocity (i.e. speed and direction). In operation block 1607, the node 110 predicts emergency vehicle position. In operation block 1609, the node 110 sends acceleration, deceleration and steering control signals to each registered vehicle within a distance from the emergency vehicle so that the vehicles clear a pathway for the emergency vehicle to safely pass.

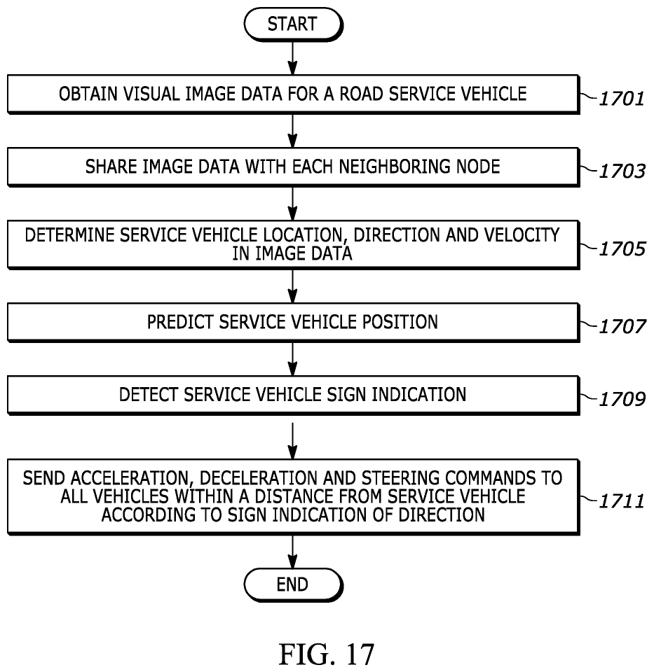

FIG. 17 is a flow chart showing a method of operation of an automated vehicle control distributed network 100 in accordance with various embodiments. The method of operation begins, and in operation block 1701 a node 110 of the automated vehicle control distributed network 100 obtains visual image data for a service vehicle on a roadway.

In operation 1701, the visual image data captures the flashing lights of service vehicles and may also detect the type of service vehicle. Examples of “service vehicles” include, but are not limited to, Department of Transportation vehicles, snowplows, street sweepers, tow trucks, engineering vehicles, department of forestry vehicles, animal control vehicles, utility service vehicles, other governmental vehicles, etc., that have flashing or rotating lights, signs indicating direction, or both of these. In operation block 1703, the node 110 shares the image data with neighboring nodes. In operation block 1705, the node 110 determines service vehicle location, and velocity (i.e. speed and direction). In operation block 1707, the node 110 predicts service vehicle position. In operation 1709, the node 110 detects a service vehicle sign indication. For example, as shown in FIG. 15, a service vehicle 1501 may have a sign indicator 1503 that directs traffic to the left or right of the service vehicle 1501. In the example of FIG. 15, the sign indicator 1503 directs traffic to move to lanes to the left of the service vehicle 1501. In this example, in operation 1709, the node 110 would detect that the sign indicator 1503 is directing traffic to move into left lanes. If a sign indicator is detected, then in operation block 1711, the node 110 sends acceleration, deceleration and steering control signals to each registered vehicle within a distance from the rear of the service vehicle so that the vehicles change lanes in accordance with the sign indicator on the service vehicle. If the service vehicle is parked and stationary, then in operation block 1711 the acceleration, deceleration and steering control signals will direct approaching vehicles to decrease speed as approaching the service vehicle and to move around the service vehicle by changing lanes if traffic conditions allow, in order to protect the individuals operating the service vehicle.

The vehicle control signals in FIG. 16 and FIG. 17 may be delivered via broadcast, unicast or multicast as determined by the situation as in other vehicle control situations. For example, unicast Internet protocol (IP) packet delivery is used to directly control the vehicles. However, around emergency vehicles or service vehicles, braking, acceleration and steering control signals may be based on an emergency vehicle or service vehicle position, such as when such vehicles are parked and stationary, and the control signals in that situation may be transmitted to multiple vehicles using broadcast packets.

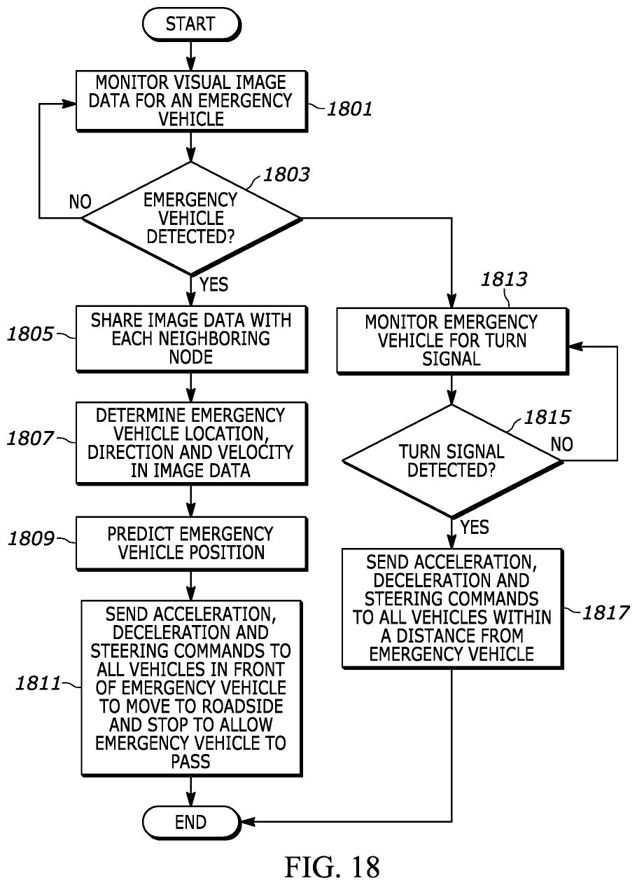

FIG. 18 is a flow chart showing a method of operation of an automated vehicle operation begins, and in operation block 1801 the automated vehicle control distributed network 100 monitors visual image data collected by the various nodes 110 using the cameras 107, for emergency vehicles. If an emergency vehicle is detected at decision 1803, then at operation 1805 the image data is shared with neighboring nodes and at operation 1807 the emergency vehicle location, and velocity (i.e. speed and direction) is determined. If no emergency vehicle is detected at decision 1803, then the automated vehicle control distributed network 100 continues to watch for emergency vehicles at operation 1801.

In operation block 1809, the automated vehicle control distributed network 100 predicts the emergency vehicle position. In operation block 1811, the automated vehicle control distributed network 100 sends acceleration, deceleration and steering control signals to each registered vehicle within a distance in front of the emergency vehicle so that the vehicles clear a pathway for the emergency vehicle to safely pass. For example, the vehicles in front of the emergency vehicle may be controlled to reduce speed, change lanes, or stop at the roadside according to conditions to allow the emergency vehicle to pass safely.

If an emergency vehicle is detected at decision 1803, the automated vehicle control distributed network 100 also monitors for a turn signal on the emergency vehicle at operation 1813. This information may be used by the automated vehicle control distributed network 100 to predict the emergency vehicle position and to help guide the vehicles in front of the emergency vehicle to the best position. If no turn signal is detected at decision 1815, then the automated vehicle control distributed network 100 continues to monitor for a turn signal at operation 1813.

If a turn signal is detected at decision 1815, then at operation 1817 the automated vehicle control distributed network 100 sends acceleration, deceleration and steering commands to all vehicles within a distance from the emergency vehicle. For example, if the emergency vehicle is changing lanes based on the turn signal direction, then vehicles within a distance, for example one mile in front of the emergency vehicle, may be commanded to change to an appropriate lane to clear the emergency vehicles path. The method of operation then terminates for that specific emergency vehicle or continues until the emergency vehicle has stopped or is out of range (has moved on to control by another set of automated vehicle control distributed network 100 nodes 110).

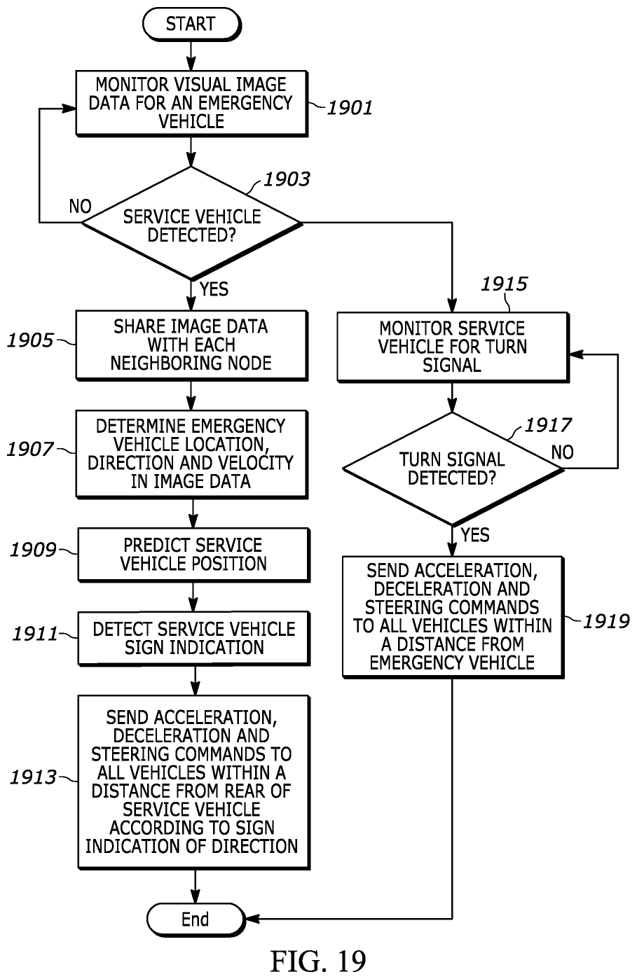

FIG. 19 is a flow chart showing a method of operation of an automated vehicle control distributed network 100 in accordance with various embodiments. The method of operation begins, and in operation block 1901 the automated vehicle control distributed network 100 monitors visual image data collected by the various nodes 110 using the cameras 107, for service vehicles. If a service vehicle is detected at decision 1903, then at operation 1905 the image data is shared with neighboring nodes and at operation 1907 the service vehicle location, and velocity (i.e. speed and direction) is determined. If no service vehicle is detected at decision 1903, then the automated vehicle control distributed network 100 continues to watch for service vehicles at operation 1901.

In operation block 1909, the automated vehicle control distributed network 100 predicts the service vehicle position. In operation 1911, the automated vehicle control distributed network 100 detects any service vehicle sign indication, if present, such as a “move left” or “move right” sign indication.

In operation block 1913, the automated vehicle control distributed network 100 sends acceleration, deceleration and steering control signals to each registered vehicle within a distance in back of the service vehicle so that the vehicles appropriately change lanes as indicated by any sign indication, or are otherwise directed to slow down and pass the service vehicle safely.

If a service vehicle is detected at decision 1903, the automated vehicle control distributed network 100 also monitors for a turn signal on the service vehicle at operation 1915. This information may be used by the automated vehicle control distributed network 100 to predict the service vehicle position and to help guide the vehicles in back of the service vehicle to the best position. If no turn signal is detected at decision 1917, then the automated vehicle control distributed network 100 continues to monitor for a turn signal at operation 1915.

If a turn signal is detected at decision 1917, then at operation 1919 the automated vehicle control distributed network 100 sends acceleration, deceleration and steering commands to all vehicles within a distance from the back of the service vehicle. For example, if the service vehicle is changing lanes based on the turn signal direction, then vehicles within a distance, for example one mile in front of the service vehicle, may be commanded to change to an appropriate lane to safely pass the service vehicle, to properly comply with a sign direction indication or both. The method of operation then terminates for that specific service vehicle or continues until the service vehicle has stopped or is out of range.

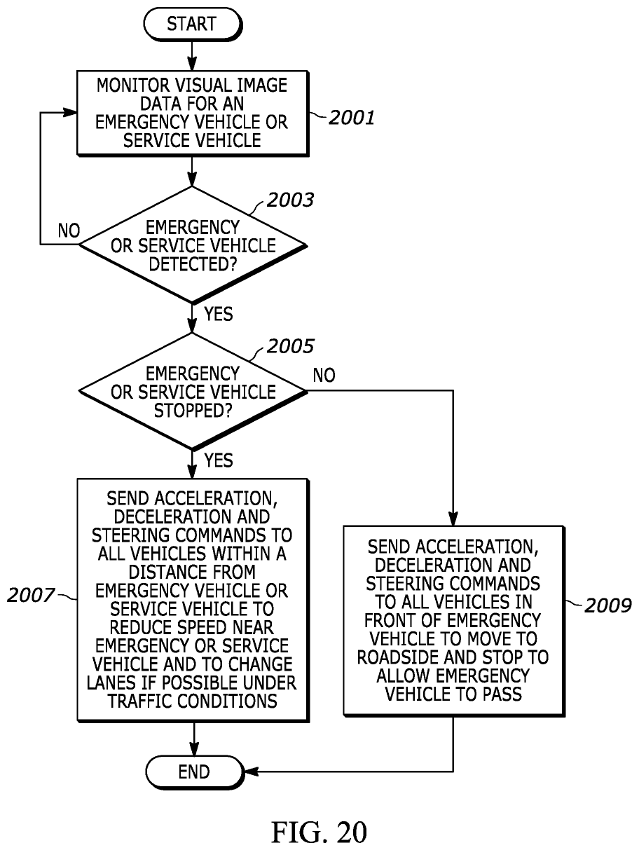

FIG. 20 is a flow chart showing a method of operation of an automated vehicle operation begins, and in operation block 2001 the automated vehicle control distributed network 100 monitors visual image data collected by the various nodes 110 using the cameras 107, for emergency vehicles or service vehicles. If no emergency vehicles or service vehicles are detected at decision 2003, then the automated vehicle control distributed network 100 continues to monitor in operation 2001.

If an emergency vehicle or service vehicle is detected at decision 2003, then at decision 2005 the automated vehicle control distributed network 100 determines if the emergency vehicle or service vehicle is stopped or parked. If the emergency vehicle or service vehicle is not stopped or parked at decision 2005, then in operation 2009 the automated vehicle control distributed network 100 sends acceleration, deceleration and steering commands to all vehicles in front of any emergency vehicle to allow the emergency vehicle to safely pass, and to all vehicles in the rear of a service vehicle to either safely pass the service vehicle and to comply with any sign direction indications.

If an emergency vehicle or service vehicle is stopped or parked at decision 2005, then in operation 2007 the automated vehicle control distributed network 100 sends acceleration, deceleration and steering commands to all vehicles within a distance from the emergency vehicle or service vehicle to reduce speed, change lanes if possible or both in accordance with the situation and with traffic conditions.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method of operating an automated vehicle control distributed network comprising:
detecting an emergency vehicle on a roadway;
creating a prediction model for the emergency vehicle; and
sending control commands to vehicles within a distance in front of the emergency vehicle to clear a path for the emergency vehicle based on the prediction model.

2. The method of claim 1, further comprising:
detecting the emergency vehicle on the roadway using a plurality of roadway high speed, high resolution cameras.

3. The method of claim 2, further comprising:
determining an emergency vehicle location and velocity using high speed, high resolution video data from the high speed, high resolution cameras.

4. The method of claim 1, further comprising:
sending control commands comprising acceleration, deceleration and steering commands.

5. The method of claim 1, further comprising:
sending control commands as multicast Internet protocol (IP) packets.

6. The method of claim 1, further comprising:
sending control commands to vehicles in front of the emergency vehicle within a distance of less than or equal to one mile in front of the emergency vehicle.

7. The method of claim 1, further comprising:
continuing to send control commands to vehicles in front of the emergency vehicle until the emergency vehicle is determined to be stationary by the automated vehicle control distributed network.

8. The method of claim 1, further comprising:
detecting a turn signal of the emergency vehicle.

9. The method of claim 8, further comprising:
sending control commands to vehicles in front of the emergency vehicle initiating a lane change based on the turn signal of the emergency vehicle.

10. A method of operating an automated vehicle control distributed network comprising:
detecting an emergency vehicle on a roadway;
determining that the emergency vehicle is stationary; and
sending control commands to vehicles approaching the emergency vehicle to reduce speed as the vehicles approach the emergency vehicle.

11. The method of claim 10, further comprising:
detecting the emergency vehicle on the roadway using a plurality of roadway high speed, high resolution cameras.

12. The method of claim 11, further comprising:
determining an emergency vehicle location using high speed, high resolution video data from the high speed, high resolution cameras.

13. The method of claim 10, further comprising:
sending control commands to vehicles approaching the emergency vehicle to initiate a lane change prior to the vehicles passing the emergency vehicle.

14. The method of claim 10, further comprising:
sending control commands comprising deceleration and steering commands.

15. The method of claim 10, further comprising:
sending control commands as multicast Internet protocol (IP) packets.

16. A method of operating an automated vehicle control distributed network comprising:
detecting a service vehicle on a roadway;
detecting a sign indication on the service vehicle indicating a direction of movement; and
sending control commands to vehicles within a distance behind the service vehicle to a path in accordance with the direction indicated by the sign direction.

17. The method of claim 16, further comprising:
detecting the service vehicle on the roadway using a plurality of roadway high speed, high resolution cameras.

18. The method of claim 17, further comprising:
determining a service vehicle location using high speed, high resolution video data from the high speed, high resolution cameras.

19. The method of claim 16, further comprising:
detecting the sign indication on the service vehicle indicating a direction of movement, using a plurality of roadway high speed, high resolution cameras.

20. The method of claim 12, further comprising:
sending the control commands to vehicles as multicast Internet protocol (IP) packets.
